(19) United States
(12) Patent Application Publication
(10) Pub. No.: US 2007/0153997 A1
(43) Pub. Date: Jul. 5, 2007

(54) Method and apparatus for implementing intelligent call service

(75) Inventor: Wanjun Shang, Shenzhen (CN)

Correspondence Address: WOLF GREENFIELD & SACKS, P.C., 600 ATLANTIC AVENUE, BOSTON, MA, 02210-2206, US

(73) Assignee: Huawei Technologies Co., Ltd., Shenzhen (CN)

(21) Appl. No.: 11/703,580

(22) Filed: Feb. 7, 2007

Related U.S. Application Data
(63) Continuation of application No. PCT/CN06/01399, filed on Jun. 20, 2006.

(30) Foreign Application Priority Data
Jun. 29, 2005 (CN) CN2005/10088751.7
Jul. 1, 2005 (CN) CN2005/10080332.6

(51) Int. Cl. H04M 15/00

(52) U.S. Cl. 379/114.29

(57) ABSTRACT

A method for implementing Intelligent Call Service, includes: allocating a unique number to a user, storing the unique number and a plurality of terminal numbers bound with the unique number, the user's Presence status and the routing order corresponding to the user's presence status; when the system receives a call for calling the unique number, determining a routing order according to the user's Presence status information corresponding to the unique number; determining corresponding terminal numbers bound with the unique number according to the routing order and issuing the call sequentially or simultaneously to the corresponding terminal numbers. An apparatus for implementing Intelligent Call Service is also disclosed. The embodiments of the present invention integrate the advantages of Presence service and Intelligent Call Routing service, and provide better service to users.

### FIELD OF THE INVENTION

The present invention relates to communication field, particularly to a method and an apparatus for implementing Intelligent Call Service which combines Presence service and Intelligent Call Routing (ICR) service in an Intelligent Network.

### BACKGROUND OF THE INVENTION

With the popularization of the Internet and the development of the Next Generation Network (NGN), various value-added services are provided, such as Presence service and ICR service in Intelligent Network.

Presence service is an auxiliary means for communication. A User could subscribe to some Presence status information of other users through Presence service, the Presence status information including the basic status such as online, leaving etc. and various extended status such as home-online, office-online, dinner-leaving, meeting-offline etc. Users can set their Presence status information at any moment and inform their friends and colleagues about the change of status information through a Presence server, also can subscribe to the current status information of their friends.

The main functional entity to implement Presence service in a network is the Presence server which has the main functions of storing the Presence-users' account number information, processing the Presence-users' registration, logging in and requesting for various operations, accepting status notification or subscription request of Presence users.

A Presence client is a client entity by which Presence users can accept status notification or subscribe to status request. It interacts with a Presence server through the Session Initial Protocol (SIP).

Whereas Presence service is convenient for a user's friends and colleagues to obtain the user's Presence status information, because the user usually uses terminals with different numbers in different routing status. (Such as, his home phone-number should be dialed when his current status is home-online; and his office phone-number should be dialed when his current status is office-online), the user needs to memorize several contact phone-numbers of the called end to implement instant communication, which brings inconvenience to the user.

ICR service may implement setting a unique number which is bound with a plurality of user terminal numbers for each user, and storing the connection order set by the user for each terminal in different routing status. When there is an incoming call, the system selects the customized connection order according to the user's current routing status and connects the call.

Though a call route can be selected according to a user's customization in ICR service, the called party's current routing status can not be obtained by the calling party who initiates the call. Thus the calling party is unable to decide whether to initiate the call or not according to the called party's current routing status. The user's experience for using the service is affected.

### SUMMARY OF THE INVENTION

According to an embodiment of the present invention, there is provided a method and an apparatus for implementing Intelligent Call Service, in order to implement the combination of Presence service and ICR service.

The method includes:
receiving a call request for calling a unique number of a user;
obtaining the user's Presence status information according to the unique number and determining a routing order;
determining corresponding terminal numbers bound with the unique number according to the routing order; and,
issuing the call to the corresponding terminal numbers.

An embodiment of the present invention provides an apparatus for implementing Intelligent Call Service, including:
an incoming call access module, receiving a call request for calling a unique number of a user and forward the call to an intelligent route selecting module;
an intelligent route selecting module, querying a database according to the unique number to obtain Presence status information of the called user, determining a routing order, determining corresponding terminal numbers bound with the unique number according to the routing order and notifying a ringing module;
a ringing module, issuing a ringing call to the corresponding terminal numbers.

An embodiment of the present invention provides a Presence server, including:
a Presence status information receiving unit, interacting with a Presence client to obtain or update a user's Presence status information;
a synchronous interface, synchronously updating the user's Presence status information stored locally and the user's Presence status information stored in an ICR server.

An embodiment of the present invention provides an Intelligent Call Routing (ICR) server, including:
an access module, interacting with a client to obtain or update a user's Presence status information;
a synchronous interface, synchronously updating the user's Presence status information stored locally and the user's Presence status information stored in an ICR server;
a service logic module, obtaining the user's Presence status information corresponding to the unique number, determining a routing order, determining the corresponding terminal numbers bound with the unique number according to the routing order, and issuing a call to the corresponding terminal numbers.

The embodiments of the present invention realizes advantage complementation between characteristics of Presence service and characteristics of ICR service, and meets users' demands.

### BRIEF DESCRIPTION OF THE DRAWINGS

FIG. 1 is a schematic diagram of a network system architecture according to an embodiment of the present invention;

FIG. 2 is a flow chart of setting a user's Presence status information via the Presence client according to an embodiment of the present invention;

FIG. 3 is a schematic diagram of a connection between an ICR server and a Presence server according to an embodiment of the present invention;

FIG. 4 is a flow chart of setting a user's Presence status information and implementing synchronous update via IVR service process by a user according to an embodiment of the present invention;

FIG. 5 is a flow chart of setting a user's Presence status information and implementing synchronous update via a Presence client by a user according to an embodiment of the present invention;

FIG. 6 is a flow chart of synchronous signaling interaction between an ICR server and a Presence server according to an embodiment of the present invention;

FIG. 7 is a flow chart of processing an incoming call according to an embodiment of the present invention.

### DETAILED DESCRIPTION

According to an embodiment of the present invention, a method for implementing Intelligent Call Service is used in an Intelligent Network system. The method includes:
allocating a unique number to a user, storing the unique number and a plurality of terminal numbers bound with the unique number, the user's Presence status and a routing order corresponding to the user's presence status information;
on receiving a call request for calling the unique number, determining a routing order according to the user's Presence status information corresponding to the unique number; determining corresponding terminal numbers bound with the unique number according to the routing order and issuing the call sequentially or simultaneously to the corresponding terminal numbers.

According to an embodiment of the present invention, a corresponding apparatus for implementing Intelligent Call Service is provided, including:
a database, storing a unique number allocated to a user, a plurality of user terminal numbers bound with the unique number, the user's Presence status information and a routing order corresponding to the user's Presence status information;
a service logic module, selecting a routing order according to the user's Presence status information corresponding to the unique number on receiving a call request for calling the unique number; determining the corresponding terminal numbers bound with the unique number according to the routing order and issuing the call sequentially or simultaneously to the corresponding terminal numbers.

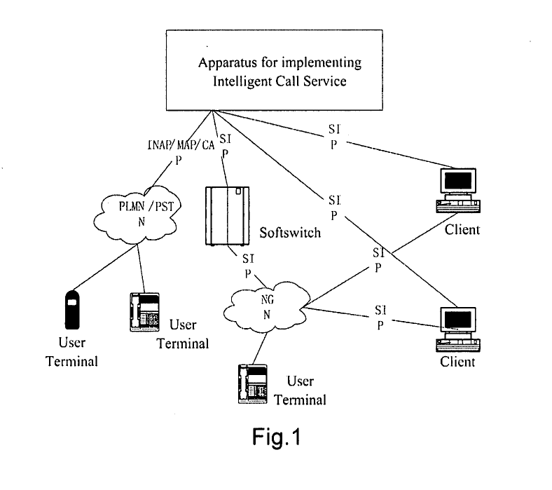

FIG. 1 is a schematic diagram of a network system architecture according to an embodiment of the present invention. As shown in FIG. 1, the user terminal that registers for Intelligent Call Service according to an embodiment of the present invention connects to the apparatus for implementing the Intelligent Call Service provided by an embodiment of the present invention via various access networks, such as PLMN (Public Land Mobile Network) PSTN (Public Switch Telephone Network) or NGN (Next Generation Network).

Hereinafter the method will be described in detail with reference to embodiments and the following figures.

In an embodiment 1, a Presence server obtains a user's Presence status information by interacting with a Presence client.

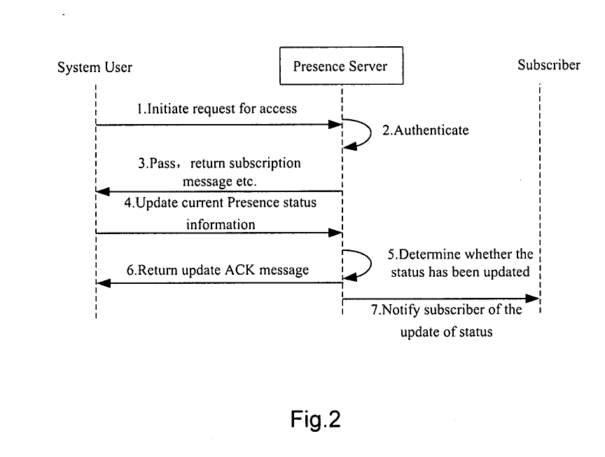

As shown in FIG. 2, it is a flow chart of setting a user's Presence status information via the Presence client according to an embodiment of the present invention, including the following process:

Step 1. a user sends an access request to a Presence server by inputting an account number and a password by means of the Presence client;

Step 2. the Presence server authenticates the user;

Step 3. the Presence server notifies the user of the authentication result; if the authentication is passed, the Presence server returns other users' subscription messages to the client;

Step 4. the user sends a request for updating current Presence status information to the Presence server according to actual needs;

Step 5. the Presence server determines whether the Presence status information stored locally is the same as the Presence status information inputted by the user in order to decide whether the user's Presence status information needs to be updated;

Step 6. if the Presence status information stored locally is the same as the Presence status information inputted by the user, the user is prompted that the Presence status information has been stored; otherwise, the user's Presence status information stored locally is updated with the Presence status information currently inputted by the user and a message of successful update is returned;

Step 7. the Presence server notifies the corresponding subscribers of the update of the user's Presence status information.

The user can also subscribe to other system users' Presence status information from the Presence server via the Presence client.

A user information table is stored in a system database, as shown in Tab. 1. For example, a user's nickname, password, a user's unique number and a plurality of terminal numbers bound with the unique number, a user's Presence status information, a voice-mailbox number and a user's IP address, etc. are included in the table.

TABLE 1
User Information Table

| | | | Presence | Bound | Bound | | Bound |
|---|---|---|---|---|---|---|---|
| Record | User's | Unique | status | number | number | | number |
| number | nickname | number | information | 1 | 2 | . . . | N |
| 1 | . . . | | | | | | |
| 2 | | | | . . . | | | |
| . . . | | | | | | | |
| N | | | | | | | . . . |

An intelligent routing order table is also stored in the system database. As shown in Tab. 2, a user's unique number, a user's Presence status information and a corresponding routing order are included in the table.

TABLE 2
Intelligent Routing Order Table

| | User's | User's Presence | |
|---|---|---|---|
| Record | unique | status | Routing |
| number | number | information | order |
| 1 | | Home-online | 213 |
| . . . | . . . | | . . . |
| N | | Office-online | 312 |

In Tab. 2, the routing order refers to a connection order of communication terminals pre-customized by the user according to the user's current Presence status information. For example, the routing order is 213, meaning that the bound number 2 (such as home phone-number) bound with the user's unique number is firstly connected, secondly the bound number 1 (such as mobile phone-number) is connected, lastly the bound number 3 (such as office phone-number) is connected. The system can also be set to synchronously connect all these terminal numbers. Calls to other terminals are stopped when one of these terminals is picked up.

The user's Presence status information in Tab. 1 and Tab. 2 are updated by the Presence server.

On receiving a call request for calling the unique number, the service logic module queries Tab. 2 according to the unique number to obtain corresponding Presence status information and gets a matched routing order; then queries Tab. 1 according to the matched routing order to determine the corresponding terminal numbers bound with the unique number and issues the call sequentially or simultaneously to the corresponding terminal numbers.

In an embodiment 2, a Presence server and an ICR server are provided in the system and a user's Presence status information is updated via a synchronous interface.

As shown in Tab. 3, a user Presence status information table is stored in the Presence server.

TABLE 3
User Presence Status Information Table

| Record | User's unique | Current Presence status |
|---|---|---|
| number | number | information |
| 1 | 111 | Mobile-online |
| . . . | . . . | . . . |
| N | 333 | Office-online |

The ICR server includes a database and a service logic module, stores the user information table and the intelligent routing order table, as shown in the Tab. 1 and Tab. 2.

The Presence server interacts with the Presence client to obtain and update a user's Presence status information. The detailed method is shown as the process in FIG. 2, and will not be described again.

The ICR server and the Presence server are connected via a synchronous interface. When the user's Presence status information in the Presence server is updated, the user's Presence status information stored in the ICR server is synchronously updated via the synchronous interface.

When the system receives a call request for calling the unique number, the service logic module in the ICR server queries Tab. 2 stored in the database to obtain corresponding Presence status information and gets a matched routing order; then queries Tab. 1 according to the matched routing order to determine corresponding terminal numbers bound with the unique number and issues the call sequentially or simultaneously to the corresponding terminal numbers.

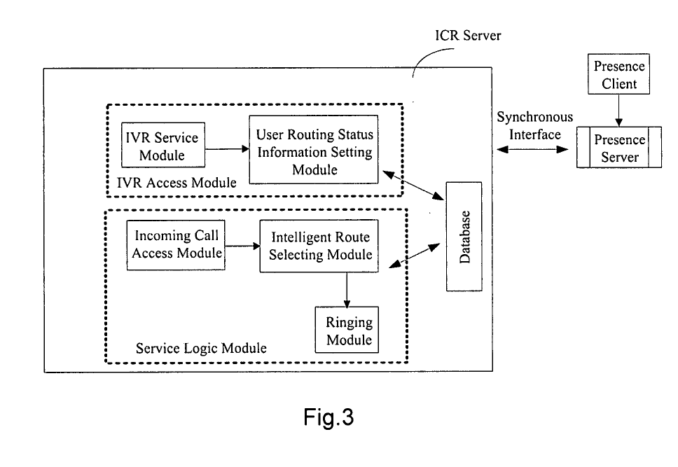

FIG. 3 is a schematic diagram of a connection between an ICR server and a Presence server. Wherein, the ICR server includes a database and a service logic module. The service logic module includes:
an incoming call access module, receiving a call request for calling a unique number of a user and forward the call to an intelligent route selecting module;
an intelligent route selecting module, querying a database according to the unique number to obtain Presence status information of the called user, determining a routing order, determining corresponding terminal numbers bound with the unique number according to the routing order and notifying a ringing module;
a ringing module, issuing a ringing call sequentially or simultaneously to the corresponding terminal numbers.

The unique number information allocated to the registered user, the information of a plurality of communication terminal numbers bound with the user's unique number, the user's Presence status information and the routing order corresponding to the user's Presence status information are stored in the database.

The ICR server also includes an IVR (Interactive Voice Response) access module which includes an IVR service module and a user routing status information setting module. The IVR access module allows a user terminal which dials the corresponding access number of IVR service to access the system and implements information interacting with the user terminal by means of voice, receives the Presence status information inputted by the user and forwards it to the Presence server via the synchronous interface.

In this embodiment, a user's Presence status information can be updated in two manners.

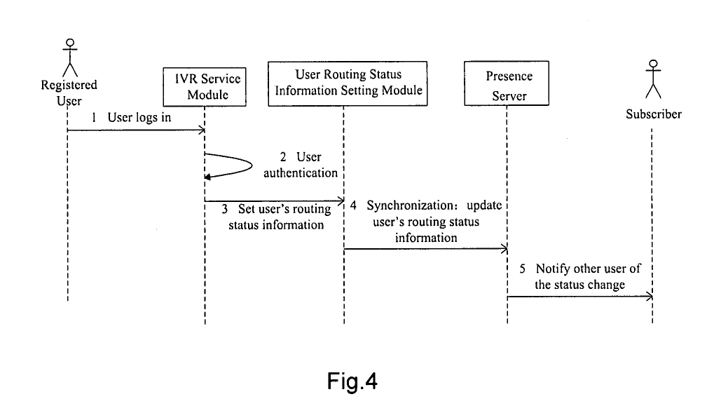

Manner 1: A user sets the user's Presence status information via IVR service process. As shown in FIG. 4, the detailed process is as follows:

Step 1, the user dials the access number of IVR service via any communication client, inputs his own unique number and password, logs in the IVR service system which is provided in the IVR service module;

Step 2, the IVR service system starts an IVR service process to perform an authentication for user validity;

Step 3, the user interacts with the system by means of voice and sets the user's current Presence status information according to the voice prompt of the system; for example, the voice prompt of the system are “please press 1 in mobile status”, “please press 2 in home-online”, etc., after the user completes the setting, the user routing status information setting module updates the user's Presence routing status information stored in Tab. 2;

Step 4, the ICR server sends a request for updating Presence status information to the Presence server and synchronously updates the status information in the Presence server;

Step 5, the Presence server notifies subscribers of the status update.

The above process also includes: the user routing status information setting module compares the current Presence status information inputted by the user with the stored Presence status information, if they are the same, prompts that the user's Presence status information has been stored and does not need synchronizing with the Presence server to update the Presence status information; if they are not the same, updates the Presence status information and prompts that the user's update is successful.

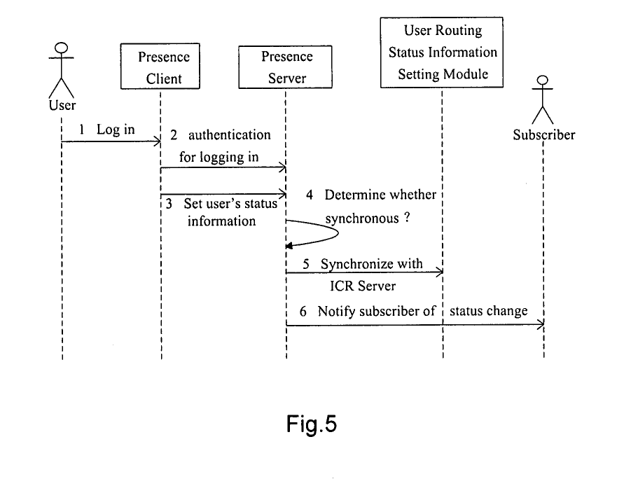

Manner 2: a user sets the user's Presence status information via a Presence client. The flow chart of the setting is shown in FIG. 5. The detailed process is as follows:

Step 1, the user inputs an account number, password via the Presence client and logs in the Presence server;

Step 2, the Presence server authenticates the account number and returns authentication result information;

Step 3, if the user logs in successfully, the user can set current Presence status information according to actual needs;

Step 4, the Presence server determines whether the stored Presence status information is the same as the current Presence status information inputted by the user in order to decide whether the Presence status information needs to be updated and synchronized; if they are the same, the following steps are performed; otherwise, returns directly to the user that the Presence status information has been stored, and finishes the setting process;

Step 5, the Presence server sends a request for synchronously updating the user's Presence status information to the ICR server and synchronously updates the user's Presence status information in the ICR server;

Step 6, the Presence server notifies other subscribers of the update of the user's Presence status.

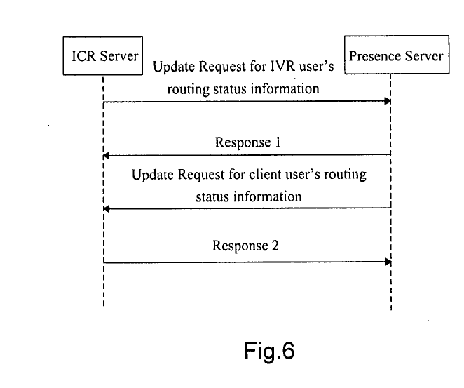

The Presence server and the ICR server are connected by a synchronous interface, the SIP (Session Initiation Protocol), XCAP (XML Configuration Access Protocol), SOAP (Simple Object Access Protocol) or HTTP (Hyper Text Transfer Protocol), etc., may be adopted as the communication protocol. The detailed synchronizing process is shown in FIG. 6. Synchronizing messages are:

Updating request message for Presence status information sent by the ICR server to the Presence server (updating request for IVR user routing status information) includes: {message ID, user's unique number, updated routing status information, user's property};

Response message 1 returned from the Presence server includes: {message ID, operation result}.

Updating request message for routing status information sent by the Presence server to the ICR server (updating request for client user routing status information) includes: {message ID, user's unique number, updated routing status information, user's property};

Response message 2 returned from the ICR server includes: (message ID, operation result}.

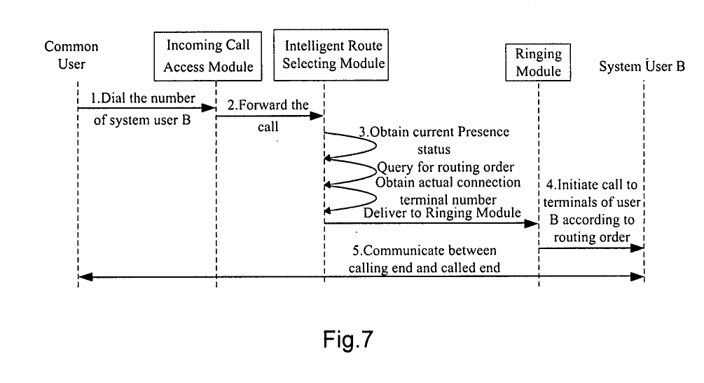

When an Intelligent Network System receives an incoming call to a user's unique number, the logic processing process of the incoming call, as shown in FIG. 7, further includes:

Step 1, user A dials the unique number of system user B, the call accesses the system via the incoming call access module in the ICR server;

Step 2, the incoming call access module forwards the call to the intelligent route selecting module;

Step 3, the intelligent route selecting module queries the database according to the unique number of the called end to obtain Presence status information of the called end, then looks up the routing order pre-customized by the user according to the obtained Presence status information and obtains actual connection terminal number information in the routing order; then sends the obtained actual connection terminal number information to the ringing module;

Step 4, the ringing module issues a ringing call to each terminal number sequentially or simultaneously according to the system setting;

Step 5, the ringing is stopped after a ringing terminal is picked up, and the talk between the calling end and the called end is implemented.

Apparently, those skilled in the art could make various modifications and variations to the present invention without departing from the spirit and scope of the present invention. Thus, if these modifications and variations are within the scope of the claims of the present invention and its equivalent, the present invention intends to contain these modifications and variations.

What is claimed is:

1. A method for implementing Intelligent Call Service, comprising:
receiving a call request for calling a unique number of a user;
obtaining the user's Presence status information according to the unique number and determining a routing order;
determining corresponding terminal numbers bound with the unique number according to the routing order; and,
issuing the call to the corresponding terminal numbers.

2. The method of claim 1, wherein the issuing the call to the corresponding terminal numbers comprises sequentially issuing the call to the corresponding terminal numbers.

3. The method of claim 1, wherein the issuing the call to the corresponding terminal numbers comprises simultaneously issuing the call to the corresponding terminal numbers.

4. The method of claim 1, further comprising:
allocating a unique number to a user, storing the unique number and a plurality of terminal numbers bound with the unique number, the user's Presence status and the routing order corresponding to the user's presence status.

5. The method of claim 1, wherein the obtaining the user's Presence status information further comprises:
logging in a Presence server via a Presence client and inputting the user's current Presence status information;
determining whether the user's Presence status information stored locally is the same as the inputted Presence status information; if it is the same, prompting that the user's Presence status information has been stored, otherwise, updating the user's Presence status information stored locally and returning a message of successful update.

6. The method of claim 1, wherein, on receiving a call request for calling a unique number of a user, an Intelligent Call Routing (ICR) server determines a routing order according to the user's Presence status information corresponding to the unique number; and determines corresponding terminal numbers bound with the unique number according to the routing order and issues the call to the corresponding terminal numbers.

7. The method of claim 1, wherein the obtaining the user's Presence status information further comprises:
dialing an access number corresponding to Interactive Voice Response (IVR) service via a user terminal and logging in an IVR service system in an ICR server;
inputting the user's current Presence status information according to prompt voice of the IVR service system;
determining whether the user's Presence status information stored in a local database is the same as the Presence status information inputted by the user; if it is the same, prompting that the user's Presence status information has been stored, otherwise updating the user's Presence status information stored in the local database and returning a message of successful update.

8. The method of claim 5, further comprising:
when updating the user's Presence status information, synchronously updating the user's Presence status information stored in the Presence server and the user's Presence status information stored in the ICR server.

9. The method of claim 7, further comprising:
when updating the user's Presence status information, synchronously updating the user's Presence status information stored in the Presence server and the user's Presence status information stored in the ICR server.

10. An apparatus for implementing Intelligent Call Service, comprising:
an incoming call access module, receiving a call request for calling a unique number of a user and forward the call to an intelligent route selecting module;
an intelligent route selecting module, querying a database according to the unique number to obtain Presence status information of the called user, determining a routing order, determining corresponding terminal numbers bound with the unique number according to the routing order and notifying a ringing module;
a ringing module, issuing a ringing call to the corresponding terminal numbers.

11. The apparatus of claim 10, further comprising:
a database, storing a unique number allocated to a user, a plurality of user terminal numbers bound with the unique number, the user's Presence status information and a routing order corresponding to the user's Presence status information.

12. A Presence server, comprising:
a Presence status information receiving unit, interacting with a Presence client to obtain or update a user's Presence status information;
a synchronous interface, synchronously updating the user's Presence status information stored locally and the user's Presence status information stored in an ICR server.

13. The Presence server of claim 12, further comprising:
a database, storing a unique number allocated to a user, a plurality of user terminal numbers bound with the unique number, the user's Presence status information and a routing order corresponding to the user's Presence status information.

14. An Intelligent Call Routing (ICR) server, comprising:
an access module, interacting with a client to obtain or update a user's Presence status information;
a synchronous interface, synchronously updating the user's Presence status information stored locally and the user's Presence status information stored in an ICR server;
a service logic module, obtaining the user's Presence status information corresponding to the unique number, determining a routing order, determining the corresponding terminal numbers bound with the unique number according to the routing order, and issuing the call to the corresponding terminal numbers.

15. The ICR server of claim 14, further comprising:
a database, storing a unique number allocated to a user, a plurality of user terminal numbers bound with the unique number, the user's Presence status information and a routing order corresponding to the user's Presence status information.

16. The ICR server of claim 14, wherein the service logic module comprises:
an incoming call access module, receiving a call request for calling a unique number of a user and forward the call to an intelligent route selecting module;
an intelligent route selecting module, querying a database according to the unique number to obtain Presence status information of the called user, determining a routing order, determining corresponding terminal numbers bound with the unique number according to the routing order and notifying a ringing module;
a ringing module, issuing a ringing call to the corresponding terminal numbers.
